(19) United States
(12) Patent Application Publication
(10) Pub. No.: US 2018/0365839 A1
(43) Pub. Date: Dec. 20, 2018

(54) SYSTEMS AND METHODS FOR INITIALIZATION OF TARGET OBJECT IN A TRACKING SYSTEM

(71) Applicant: SZ DJI TECHNOLOGY CO., LTD., Shenzhen City, Guangdong (CN)

(72) Inventors: Xuyang FENG, Shenzhen (CN); Cong ZHAO, Shenzhen (CN); Zhe YANG, Shenzhen (CN)

(73) Assignee: SZ DJI TECHNOLOGY CO., LTD., Shenzhen City, Guangdong (CN)

(21) Appl. No.: 16/061,896

(22) PCT Filed: Sep. 27, 2016
(86) PCT No.: PCT/CN2016/100361

§ 371 Date: Jun. 13, 2018

(51) Int. Cl. G06T 7/194; G06T 7/215; G06T 5/00; H04W 4/029; G06K 9/00; B64C 39/02; G06N 3/08

(52) U.S. Cl. CPC G06T 7/194; G06T 7/215; G06T 5/002; H04W 4/029; G06K 9/00288; G06T 2207/20081; B64C 39/024; G06N 3/08; B64C 2201/123; B64C 2201/127; B64C 2201/145; G06K 9/00268

(57) ABSTRACT

The disclosed embodiments include methods, apparatuses, systems, and UAVs configured to an interactive and automatic initialization of the tracking systems. The disclosed embodiments observe an object of interest in a surrounding of the movable object and detect a feature of the object of interest, which acts as a trigger for automatically initializing the tracking system. As a result, the disclosed embodiments may provide efficiency and reliability to initializing a robotic system.

### COPYRIGHT NOTICE

A portion of the disclosure of this patent document contains material that is subject to copyright protection. The copyright owner has no objection to the facsimile reproduction by anyone of the patent document or the patent disclosure, as it appears in the patent and trademark office patent file or records, but otherwise reserves all copyright rights whatsoever.

### TECHNICAL FIELD

The present disclosure relates generally to tracking moving objects and, more particularly, to systems and methods of automatic initializing a tracking system.

### BACKGROUND

Unmanned aerial vehicles (“UAV”), commonly known as drones, include pilotless aircraft that can be remotely piloted by a user or programmed for autonomous flight by onboard systems. Often UAVs may be equipped with imaging equipment, such as cameras, video cameras, etc., which allows the user to capture images or video footages. The imaging equipment also allows the UAV to intelligently track, that is, monitor the location of, a target object through use of a tracking system.

### SUMMARY

The disclosed embodiments include methods and systems configured to provide automatic initializing of a movable object and identification of a target object. The disclosed embodiments may receive an image, extract a foreground of the image, identify the target object in the foreground, and track the target object.

In some embodiments, for example, the disclosed embodiments may receive the image in combination with a GPS location. The disclosed embodiments may receive the image while the movable object is in one of translational flight or hovering flight. The disclosed embodiments may calculate at least one of a relative speed or direction of the movable object while the movable object is in translational flight.

The disclosed embodiments may select the target object for tracking. For example, the selecting may be based on at least one of facial recognition, user profile, motion detection, or user selection. In some embodiments, the selecting of the target object for tracking may be without user intervention if the target object matches a user profile.

In some embodiments, the movable object may observe an object in a surrounding of the movable object and detect a feature of the object as a trigger for initializing the tracking function. For example, the observing may comprise scanning the surrounding and sensing for the object by one or more sensors in real time. The one or more sensors may comprise at least one of vision, ultrasonic, or sonar sensor. In some embodiments, the sensing may be accomplished in combination with a global positioning system (GPS) location, wherein the GPS location may be a location of a wearable device.

In some embodiments, the tracking function may comprise receiving an image, extracting a foreground of the image, identifying the object in the foreground, and tracking the object. In such embodiments, the tracking function may comprise tracking the object providing the feature for the trigger. Alternatively, the tracking function may comprise tracking a second object identified in the tracking function.

In some embodiments, the detecting comprises detecting a kinematic feature related to the object. The kinematic feature may be a gesture. The kinematic feature may also be received from a wearable device. In some embodiments, the detecting may comprise recognizing a feature of the object. For example, the detecting may determine if the object is a known user based on recognizing a facial feature. The disclosed embodiments may further confirm the external trigger by visual notification. In some embodiments, the disclosed embodiments may determine control signals based on the detected feature.

Consistent with the disclosed embodiments, the disclosed embodiments may also identify a target object by receiving an image, detecting an attribute of the image, selecting a portion of the image containing the detected attribute, and processing the selected portion of the image through a neural network to identify the target object. For example, the neural network may be a deep learning neural network. In some disclosed embodiments, the detecting an attribute of the image may comprise detecting a perceived movement in the image. In some disclosed embodiments, the processing may further determine a set of control signals corresponding to the detected attribute.

The techniques described in the disclosed embodiments may be performed by any apparatus, system, or article of manufacture, including a movable object such as a UAV, or any other system configured to track a moving object. Unlike prior electronic speed control systems, the disclosed embodiments provide additional reliability and robustness. It is to be understood that both the foregoing general description and the following detailed description are exemplary and explanatory only and are not restrictive of the disclosed embodiments as defined in the claims.

### BRIEF DESCRIPTION OF DRAWINGS

The accompanying drawings, which are incorporated in and constitute a part of this specification, illustrate several embodiments and, together with the description, serve to explain the disclosed principles. In the drawings:

FIG. 1 is a schematic diagram of an exemplary system that may be used to provide an automatic initialization system consistent with the disclosed embodiments.

FIG. 2 is a schematic block diagram of an exemplary controller that may be used to provide an automatic initialization system consistent with the disclosed embodiments.

FIG. 3 is a schematic block diagram of an exemplary system that may be used to provide an automatic initialization system consistent with the disclosed embodiments.

FIG. 4 is a flowchart illustrating an exemplary sequence of steps that may be performed for identifying a target object consistent with the disclosed embodiments.

FIG. 5a-d are exemplary views showing various stages of image processing for identifying a target object consistent with the disclosed embodiments.

FIG. 6 is a flowchart illustrating an exemplary sequence of steps that may be performed for automatically initializing a tracking system consistent with the disclosed embodiments.

Reference will now be made in detail to exemplary disclosed embodiments, examples of which are illustrated in the accompanying drawings and disclosed herein. Where convenient, the same reference numbers will be used throughout the drawings to refer to the same or like parts.

### DETAILED DESCRIPTION

The disclosed embodiments provide intelligent control of UAVs using automatic tracking systems and, more particularly, systems and methods of automatically initializing the tracking systems using UAVs. Unlike prior techniques, the inventive systems and methods minimize the need for user intervention and allow enhanced usability and functionality.

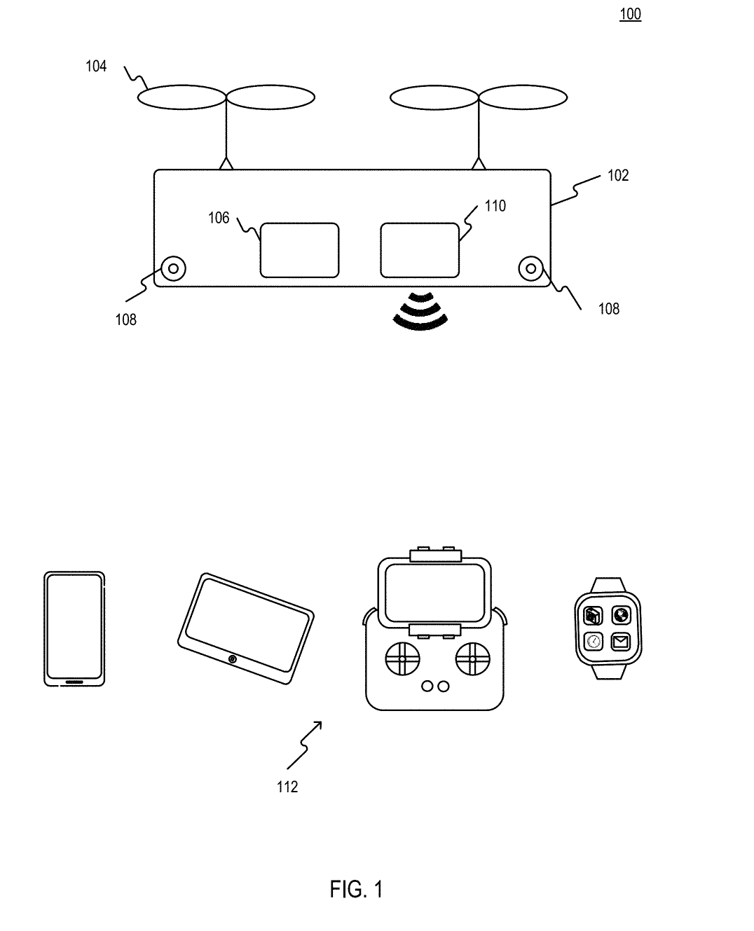

FIG. 1 is a schematic diagram of an exemplary system 100 for performing one or more operations consistent with the disclosed embodiments. System 100 may include one or more movable objects 102 of various sizes and configurations. Moveable object 102 may be, for example, UAV that is movable using one or more motorized propellers 104. Although movable object 102 is shown and described herein as a UAV for exemplary purposes of this description, it will be understood that other types of movable objects may also be used in embodiments consistent with this disclosure, as long as the movable objects may be configured to be operated and controlled via an intelligent sensing system as described herein. Thus, the movable objects may be wheeled objects (e.g., cars, bicycles, etc.), nautical objects (e.g., boats), aerial objects (e.g., aircrafts, airplanes, helicopters, quadcopters, multicopters, etc.), or the like. As used herein, the term UAV may refer to an aerial device configured to be operated and controlled autonomously (i.e., via an electronic control system) and/or manually by off-board personnel.

UAV 102 may include at least one flight controller 106 and one or more sensors 108. Flight controller 106 may comprise one or more processors, memories, and I/O devices for communicating with other components in UAV 102 or with components in system 100. For example, flight controller 106 may be configured to communicate with various components of UAV 102 including but not limited to an accelerometer, gyroscope, inertial measurement units (IMUs), altimeter, proximity sensors, ultrasonic sensors, sonar sensors, vision sensors, global positioning system (GPS), etc. These on-board sensors 108 enable UAV 102 to sense its surroundings and provide UAV 102 with the capability to detect moving objects in the surroundings. The moving objects may be any objects sensed by UAV 102. For example, the moving object may be the user. In many applications, UAV 102 may autonomously track the user, for example, to take a self-portrait photograph or action video.

Flight controller 106 also may be configured to communicate with other UAVs 102 and/or user devices 112 in system 100 using a wireless communication device 110. Flight controller 106 may process various user inputs and/or machine data, and provide autonomous control of UAV 102.

UAV 102 may communicate with user devices 112, for example, over a wireless link. UAV 102 may include an interface for communicating with user devices 112 via any appropriate wireless protocols. User devices 112 may include, but are not limited to, a general-purpose computer, a computer cluster, a terminal, a mainframe, a mobile computing device, or other computer device capable of receiving user input. In this context, a mobile computing device may include, but is not limited to, a mobile phone, a smartphone, a personal digital assistant, a tablet, a laptop, etc. Mobile computing device may further include a wearable device such as a smartwatch, a fitness tracker, a ring, a bracelet, or the like. User devices 112 may also include a standalone remote controller. Consistent with the disclosed embodiments, user devices 112 may be equipped with various sensors including, but not limited to, an accelerometer, gyroscope, IMU, GPS, or the like.

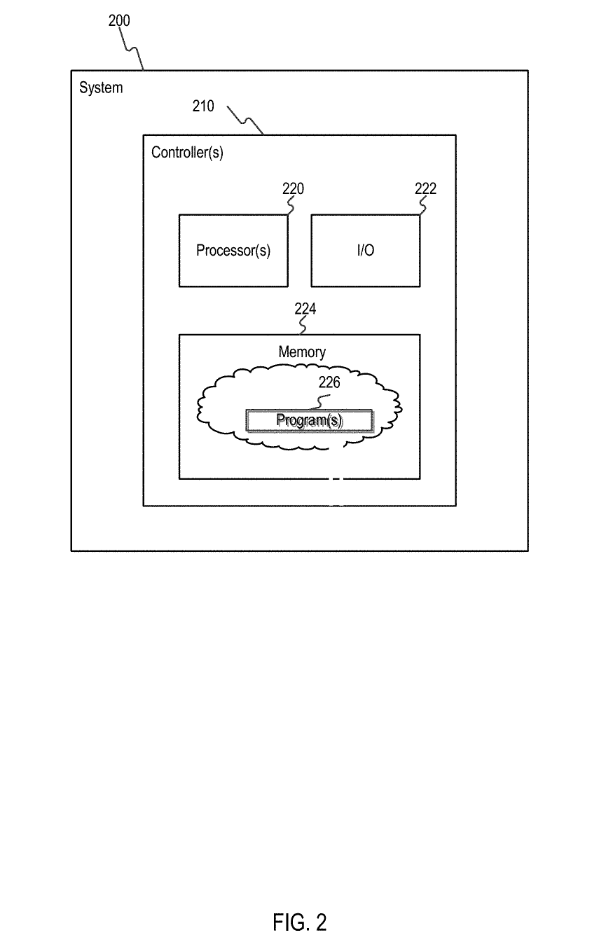

FIG. 2 is a schematic block diagram of an exemplary system 200 that may be used consistent with the disclosed embodiments. System 200, or variations thereof, may be used to implement components in system 100, including for example UAV 102. System 200 may include one or more processors 220, one or more I/O devices 222, and one or more memories 224, which in some embodiments may be implemented within one or more controllers 210. In some embodiments, system 200 may be implemented in flight controller 106. For example, system 200 may be implemented as an embedded system, such that system 200 may be a stand-alone embedded system, or it may be implemented as a subsystem in a larger system, where one or more operations in system 200 are performed using parts of the larger system.

Processor 220 may include one or more known processing devices. For example, processor 220 may be from the family of processors manufactured by Intel®, from the family of processors manufactured by Advanced Micro Devices, or the like. Alternatively, processor 220 may be based on the ARM® architecture. In some embodiments, processor 220 may be a mobile processor. The disclosed embodiments are not limited to any type of processor configured in controller 210.

I/O devices 222 may be one or more devices configured to allow data to be received and/or transmitted by controller 210. I/O devices 222 may include one or more communication devices and interfaces, and any necessary analog-to-digital and digital-to-analog converters, to communicate with other machines and devices, such as other components in system 100, including UAV 102 and/or user controller 104. In some embodiments, I/O devices 222 may enable controller 210 to communicate and interface with various on-board sensors 108 in UAV 102.

Memory 224 may include one or more storage devices configured to store software instructions used by processor 220 to perform functions related to the disclosed embodiments. For example, memory 224 may be configured to store software instructions, such as program(s) 226, that perform one or more operations when executed by processor(s) 220 to identify a target object in an image. The disclosed embodiments are not limited to software programs or devices configured to perform dedicated tasks. For example, memory 224 may include a single program 226, such as a user-level application, that performs the functions of the disclosed embodiments, or may comprise multiple software programs. Additionally, processor 220 may execute one or more programs (or portions thereof) remotely located from controller 210. For example, UAV 102 may access one or more remote software applications via user devices 112, such that, when executed, the remote applications perform at least some of the functions related to the disclosed embodiments for automatically initializing the tracking system. Furthermore, memory 224 may include one or more storage devices configured to store data for use by program(s) 226.

It is to be understood that the configurations and boundaries of the functional building blocks shown for exemplary systems 100 and 200 have been arbitrarily defined herein for the convenience of the description. Alternative implementations may be defined so long as the specified functions and relationships thereof are appropriately performed and fall within the scope and spirit of the invention.

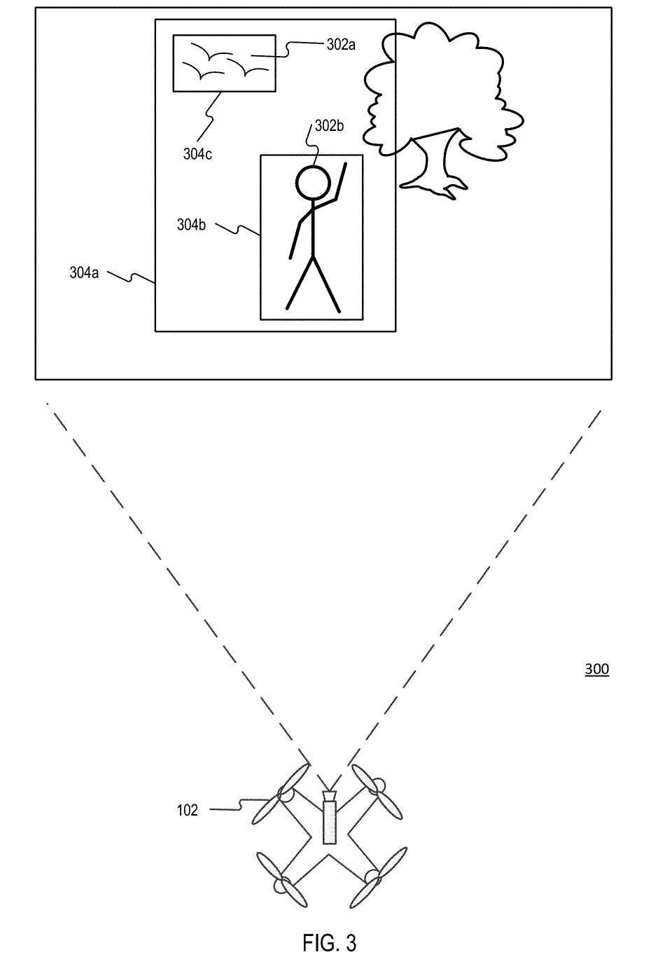

FIG. 3 is a diagram of an exemplary system 300 for automatically initializing tracking systems consistent with disclosed embodiments. In prior tracking systems, the initialization process often required manual selection of a target object In order to initialize the tracking system to track a particular object. But this takes time and requires the user to carry some type of remote control. This is inconvenient, especially in certain action sports. Other prior tracking systems may use GPS coordinates to track the user. This requires the user to carry some type of remote control with GPS capability in order for UAV to identify and track the GPS coordinates. Further such prior tracking systems may only know the general location of the target object, but cannot actually identify the target object.

Consistent with the disclosed embodiments, UAV 102 in system 300 may be equipped with various sensors, which enable UAV 102 to observe a target object, such as birds 302a or a person 302b in the environment of UAV 102 in real time. UAV 102 may detect a feature related to the target object, which acts as an external trigger prompting UAV 102 to automatically initialize its tracking function.

In some embodiments, as shown in FIG. 3, UAV 102 may be equipped with camera devices, which may enable UAV 102 to visually sense its surroundings and automatically initialize the tracking system. In such embodiments, UAV 102 may receive a stream of images or video data captured by the camera devices. UAV 102 may visually observe potential target objects in its surroundings (e.g., person and birds in FIG. 3). In another embodiment, UAV 102 may use a GPS location to determine the general vicinity for sensing its surroundings. For example, the GPS location may be obtained from a user device 112 (not shown) on person 302b.

Using various image processing algorithms, UAV 102 may detect a “trigger” feature related to the target objects. For example, the trigger feature may be a facial feature, body feature, or the like of the target object. In such an example, UAV 102 may have access to a database of user profiles, which include information related to the owner of UAV 102 or register users. If UAV 102 detects that one of the trigger features matches a user profile, the match may automatically trigger UAV 102 to automatically initialize its tracking system.

Alternatively, the trigger feature may be a kinematic feature. “Kinematic feature” broadly means any feature describing movement; for example, displacement, time, velocity, acceleration, etc. A kinematic feature may be detected by visible light, or alternatively, through various sensors including but not limited to infra-red sensors, ultrasonic sensors, inertial measurement units, accelerometers, gyroscopes, etc. Further, a kinematic feature may be detected in combination with user device 112, which may include various sensors such as inertial measurement units, accelerometers, gyroscopes, etc. For example, person 302b may have a wearable device such as a smartwatch. In such an example, UAV 102 may detect, for example, the displacement of the hand by using the inertial measurement units in the smartwatch. The disclosed embodiments are not limited to the simplified examples. Nonetheless, the detection of the trigger feature may acts as a trigger to automatically initialize the tracking function.

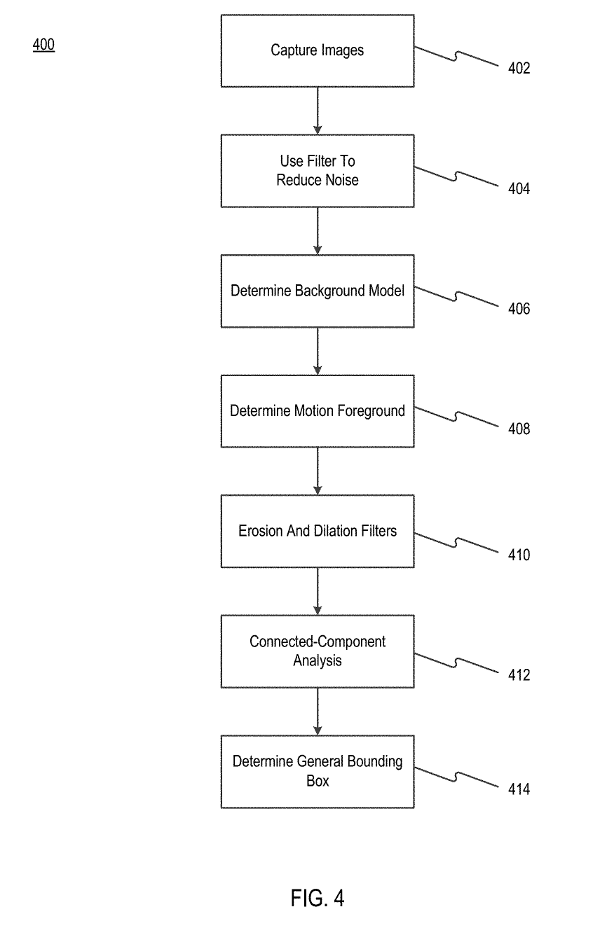

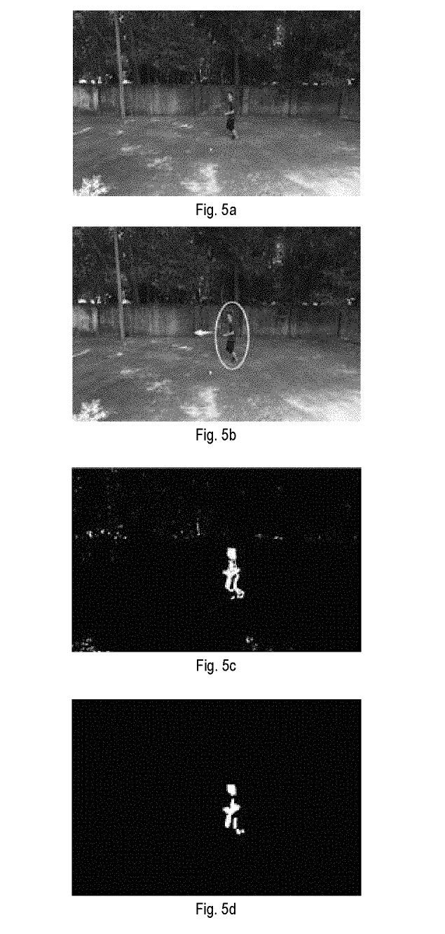

In some embodiments, UAV 102 may use its visual tracking system to detect a trigger feature of the target object in its surrounding. For example, UAV 102 may use computational imaging processing to process the images of its observed surrounding. In such an example, UAV 102 may automatically determine a background area and a foreground area, wherein the foreground area generally contains the kinematic features (e.g., movements of birds 302a and person 302b in FIG. 3). In some embodiments, UAV 102 may automatically determine a foreground area by detecting movements in the images. For example, while UAV 102 is hovering in air, the background and any static objects are essentially unchanged. Accordingly, any movements in the images could be conveniently extracted. Additional details related to the motion foreground extraction are illustrated in FIGS. 4 and 5a-5d.

In some embodiments, UAV 102 may use “deep learning,” that is, an application of an advanced neural network. Deep learning may be implemented by a multi-layered neural network. Further, deep learning may allow UAV 102 to recognize the movement, or alternatively, the object itself. In such embodiments, UAV 102 may determine a general bounding box 304a around a general area in the images with motion. As shown in FIG. 3, the general bounding box 304a may contain one or more moving objects (e.g., birds 302a flying or person 302b waving). Although the exemplary embodiments use a single general bounding box, one of ordinary skill in the art would realize that the disclosed embodiments are not so limited, and it is possible to use multiple general bounding boxes so long as the specified functions are appropriately performed.

After determining the general bounding box 304a around the moving objects (e.g., areas with kinematic features), UAV 102 may use a deep learning algorithm to analyze the general bounding box 304a. One common use of deep learning is computer vision processing. For example, deep learning may allow UAV 102 to accurately recognize and identity the moving objects in the general bounding box. For example, using deep learning, UAV 102 may identify whether each moving object is a person or other object such as an animal, a moving vehicle, or the like. As shown in FIG. 3, UAV 102 may identify that the moving object in box 304b is a person 302b, and the moving objects in box 304c are birds 302a.

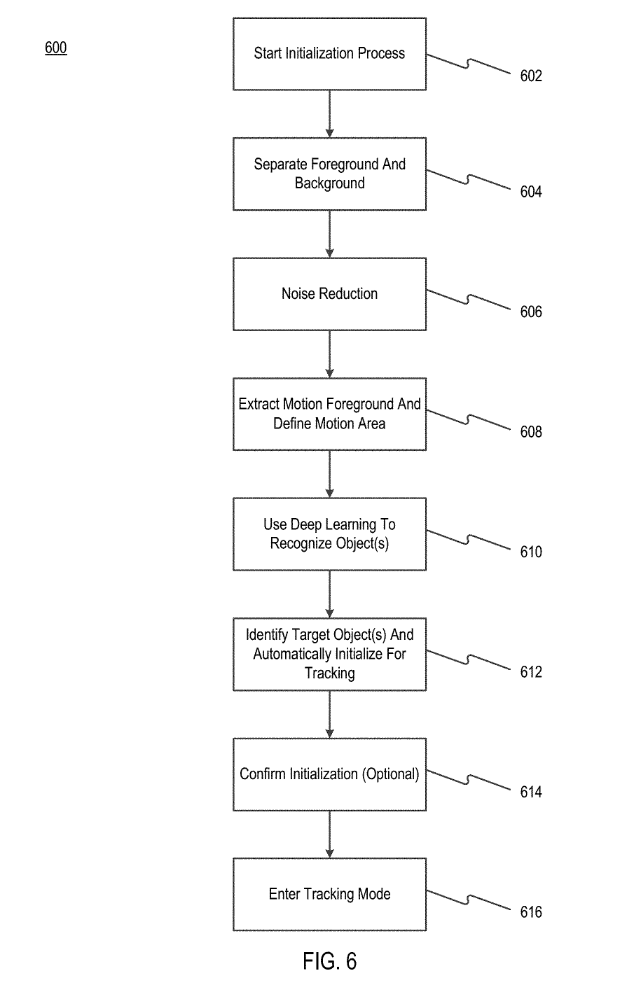

In some embodiments, deep learning may allow UAV 102 to recognize other features. For example, deep learning may allow facial recognition. In such embodiments, UAV 102 may determine if the person is an owner of UAV 102 or a registered user. This may allow UAV 102 to avoid tracking strangers or other objects, such as the birds. Deep learning may also allow UAV 102 to determine the specific movement, giving UAV 102 the ability to differentiate general kinematic features (e.g., flying birds, which may not be desired as a trigger feature) from specific gestures (e.g., a person waving, which may be desired as a trigger feature). Additional details related to using deep learning to automatically initialize the visual tracking system are illustrated in FIG. 6. This provides the visual track system with enhanced tracking ability and increases the stability of the tracking control.

In some embodiments, UAV 102 may determine refined bounding boxes 304b, 304c around the objects potentially desired to be tracked. In some embodiments, UAV 102 may track the target object which is exhibiting the trigger feature. Alternatively, UAV 102 may be directed to track another target object that may be identified during initialization or selected by the user.

One of ordinary skill in the art would realize that object identification using deep learning typically requires high computational power and large memory resources. Thus, it is difficult to implement deep learning in an embedded platform. The disclosed embodiments utilize the motion foreground extraction to reduce the image data. Thus, only a small portion of the image data is used to train the neural network, effectively reducing unnecessary calculation and ensuring real-time deep learning in the embedded platform. Accordingly, the disclosed embodiments may provide automatic initialization of visual tracking systems in real-time.

FIG. 4 shows a flowchart illustrating a sequence of steps that performs an exemplary process 400 for automatically determining a general bounding box according to the disclosed embodiments. The process of FIG. 4 may be implemented in software, hardware, or any combination thereof. For purposes of explanation and not limitation, process 400 will be described in the context of system 100, such that the disclosed process may be performed by software executing in UAV 102.

Consistent with the disclosed embodiments, UAV 102 may capture images at step 402. The images may be video images, still images, or the like. In some embodiments, UAV 102 may continuously scan its surroundings until it detects a moving object. Alternatively, UAV 102 may use GPS coordinates to help it determine where to capture the images. For example, UAV 102 may receive from user device 112 a set of GPS coordinates that indicate the location of user device 112. In such an example, the GPS coordinates may allow UAV 102 to know the general location of user device 112. In some embodiments, user device 112 may be a wearable device, which may provide a set of GPS coordinates to UAV 102. In such embodiments, UAV 102 may know the general location of the user, who is wearing the wearable device.

At step 404, UAV 102 may use various filters to reduce noise from the captured images. For example, UAV 102 may use a Gaussian filter to remove noise. Alternatively, UAV 102 may use any other suitable filters including linear filters, averaging filters, median filters, or the like for noise reduction.

At step 406, UAV 102 may determine a suitable background model for extracting the motion foreground. The background model acts as a reference for the motion foreground extraction. For example, while UAV 102 is in hovering flight, the background and any static objects may remain substantially unchanged in the captured images. Thus, by using a static background model, it may be possible to separate the motion foreground and the static background. For example, FIG. 5a shows an exemplary image that may be captured by UAV 102. In the image, the user is the only moving object as indicated by FIG. 5b. Accordingly, everything that is static may be considered as part of the background while the area in motion may be considered as the motion foreground.

During translational flight, however, the images may include an active background, since objects in the background may be moving relative to UAV 102. Accordingly, a different background model may be more suitable for translational flight situation. For example, the images may be analyzed to detect a background model using the known speed and direction of UAV 102. UAV 102 may estimate the direction and speed of its motion and use these estimates to establish a reference. Because UAV 102 is in translational flight, any stationary objects in the images should move in the opposite direction of UAV 102 at the same corresponding speed. Thus, the background model acts a reference for foreground extraction. One of ordinary skill in art would recognize that other approaches to modeling the background may also or alternatively be used in embodiments consistent with this disclosure.

Returning now to FIG. 4, at step 408, UAV 102 may determine the motion foreground. In some embodiments, UAV 102 may use background subtraction to extract the motion foreground. During this process, UAV 102 may compare the image with the determined background model. By subtraction, the background portion may be removed leaving the motion foreground. For the example discussed above with respect to FIG. 5, UAV 102 may subtract the images using the static background model. FIG. 5c shows the resulting image that is created by background subtraction. Other suitable methods of motion foreground extraction may also or alternatively be used in embodiments consistent with this disclosure.

At step 410 (FIG. 4), UAV 102 may apply various known image morphology filters to the extracted foreground image. Morphology is a set of image processing operations that process images based on shapes, by comparing each pixel with its neighbors. In some embodiments, an “erosion” operation is applied to the foreground image. Erosion is the process of removing pixels on the boundaries of objects in an image. For example, for each pixel on the boundaries of objects, UAV 102 may assign the minimum value of all its neighboring pixels. Thus, if any of the neighboring pixels is set to 0, the value of the pixel is also set to 0. Accordingly, the erosion operation may be used to remove any artifacts in the foreground that may be created due to noise, camera shakes, inaccuracy in the background model, etc. The result of the erosion process is a foreground image that may be free of any artifacts and noise.

In some embodiments, a “dilation” operation may be applied. The effect of dilation is to gradually enlarge the foreground pixels. In contrast to erosion, dilation adds pixels to the boundaries of objects in an image. For example, for each pixel on the boundaries of objects, UAV 102 may assign the maximum value of all its neighboring pixels. Dilation may ensure that the resulting foreground contains the entire moving object. FIG. 5d shows the resulting image that is created after applying the erosion and dilation operations. Other suitable methods of performing image morphology processing may also or alternatively be used in embodiments consistent with this disclosure.

At step 412 (FIG. 4), UAV 102 may perform a “connected-component” analysis on the resulting image created at step 410. For example, UAV 102 may assign certain identifiers to pixels in the image created at step 410. Any pixel that is connected to another pixel (e.g., sharing a border and having the same value) may be assigned the same identifier. Using this process, UAV 102 may assign every connected component (e.g., region of adjacent pixels having the same binary value) with a unique identifier. Other suitable methods of performing connected-component analysis may also or alternatively be used in embodiments consistent with this disclosure.

Once UAV 102 has identified the connected components by assigning unique identifiers to different pixel regions, it may detect the target object. At step 414, UAV 102 may determine a general bounding box around the detected target object.

As discussed above, UAV 102 may reduce the image data by performing the above-described process, but the disclosed embodiments are not limited to these examples. While the steps of the disclosed embodiments are described in a particular order for convenience, the practice of the disclosed embodiments are not so limited and could be accomplished in many ways and in different orders.

FIG. 6 is a flowchart illustrating a sequence of steps of an exemplary process 600 for automatically initializing a visual track system consistent with the disclosed embodiments. The process of FIG. 6 may be implemented in software, hardware, or any combination thereof. For purposes of explanation and not limitation, process 600 will be described in the context of system 100, such that the disclosed process may be performed by software executing in UAV 102.

In some embodiments, UAV 102 may enter into initialization process directly during startup. In such embodiments, the process from starting up to tracking of a target object may be completely automatic. In other embodiments, the user may select the automatic initialization function, which will start the initialization process at step 602.

Consistent with the disclosed embodiments, UAV 102 may receive a live stream of image or video data from its camera devices. This allows UAV 102 to not only sense its surroundings but provides UAV 102 with the ability to visually identify its target objects. At step 604, UAV 102 may perform various computational image analyses to separate the foreground and the background. UAV 102 may perform various image preprocessing, for example, to determine a background model. For example, while UAV 102 is in hovering flight, the background and any static objects will remain substantially unchanged. In such an example, the images have a static background. In contrast, during translational flight, the images may have an active background. For example, the background should move away in the opposite direction to the movement of UAV 102 and with the same corresponding speed. By determining the direction of its motion and its estimated speed, UAV 102 may determine a background model as reference for further image processing. Other background models may also be possible. At step 606, UAV 102 may perform noise reduction to remove noise from the images.

At step 608, UAV 102 may extract the motion foreground. One possible method is background subtraction, which allows UAV 102 to detect moving objects in its field of view. For example, while UAV 102 is in hovering flight, the background and any static objects will remain substantially unchanged. By finding the difference between the previous images and the current image, the background and static objects may be eliminated from the images. Accordingly, only movements in the images may remain. Thus, background subtraction may extract the motion foreground and eliminate the static background. As discussed above, this process, however, is not limited to hovering flight. It is similarly possible to extract the motion foreground during translational flight. For example, UAV 102 may determine a background model based on the direction of its motion and its estimated speed. Accordingly, any objects moving in an unexpected direction or speed may be extracted as the motion foreground. After the moving objects are detected, UAV 102 may define the motion foreground with a general bounding box (e.g., general bounding box 304a in FIG. 3) at step 608.

Having reduced the image data significantly by extracting the motion foreground, UAV 102 at step 610 may use deep learning to perform object recognition. Deep learning allows UAV 102 to accurately identify the moving objects in the general bounding box. For example, using deep learning, UAV 102 may recognize the moving objects in the general bounding box and identify the moving objects as a person, vehicle, animal, inanimate object, etc. One of ordinary skill in the art would realize that it is possible for deep learning to distinguish the moving objects further into finer classification depending on the quality of the training data set.

As illustrated in FIG. 3, the general bounding box 304a may contain one or more moving objects. Deep learning allows UAV 102 to recognize each object and define a refined bounding box (e.g., refined bounding box 304b, 304c of FIG. 3) around each recognized object. In some embodiments, UAV 102 may use deep learning to perform facial recognition, which may allow UAV 102 to determine whether the person in the bounding box is an owner, registered user, or stranger. Alternatively, deep learning may identify that the moving object is a vehicle, an animal.

At step 612 (FIG. 6), UAV 102 may identify the moving objects and automatically initialize the visual tracking system. For instance, if there is only one moving object in the motion foreground, UAV 102 will determine only one refined bounding box around it as the potential target object. In such instance, UAV 102 may identify this specific potential target object as the target object for tracking. When there is more than one potential target object in the motion foreground, as illustrated in FIG. 3, UAV 102 will determine a refined bounding box around each potential target object. In such a case, UAV 102 may identify each potential target object and initialize the visual tracking system with multiple potential target objects.

In some embodiments, UAV 102 may provide visual feedback to indicate that the automatic initialization process is complete. For example, UAV 102 may make a yaw rotation to face the user or position itself in the user's viewing perspective. Alternatively, the visual feedback may include flashing signal lights, or the like. In other embodiments, the feedback may be audible.

In some embodiments, after automatic initialization, UAV 102 may automatically enter into tracking mode to track the identified potential target object 302. For example, a user may store a user profile in UAV 102, which may contain information related to the user or other registered users. In such an example, the user profile may contain the user's gender, size, body shape, facial features, or the like. UAV 102 may match the identified potential target object 302 with the stored user profile, and if the match is within certain confidence range, UAV 102 may automatically track the identified potential target object 302 as the target object. Alternatively, if UAV 102 determines that the identified potential target object 302 is a stranger (e.g., the match is not within a predetermined confidence range), UAV 102 may wait for confirmation from the user before entering into tracking mode. In such embodiments, the user may confirm tracking by performing an external trigger, which may include but is not limited to, physical movements such as jumping, moving, waving, gesturing, or the like, or selecting the target object in a user remote control.

In some embodiments, UAV 102 may wait for confirmation before entering into tracking mode. For example, UAV 102 may wait for an external trigger before entering into tracking mode. Alternatively, UAV 102 may have identified a plurality of potential target objects during the automatic initialization process. Thus, there may be one or more refined bounding boxes, each containing a potential target object. In such embodiments, the user may confirm the target object via a remote controller by selecting a specific bounding box and transmitting the selection to UAV 102. The disclosed systems and methods are not limited to these simplified examples, and other features and characteristics may be considered so long as the specified functions are appropriately performed.

While certain disclosed embodiments have been discussed with respect to UAVs for purposes of discussion, one skilled in the art will appreciate the useful applications of disclosed methods and systems for identifying target objects. Furthermore, although aspects of the disclosed embodiments are described as being associated with data stored in memory and other tangible computer-readable storage mediums, one skilled in the art will appreciate that these aspects can be stored on and executed from many types of tangible computer-readable media. Further, certain processes and steps of the disclosed embodiments are described in a particular order, one skilled in the art will appreciate that practice of the disclosed embodiments are not so limited and could be accomplished in many ways. Accordingly, the disclosed embodiments are not limited to the above-described examples, but instead are defined by the appended claims in light of their full scope of equivalents.

1-66. (canceled)

67. A method of tracking a target object by a movable object, comprising:
receiving an image;
extracting a foreground of the image;
identifying the target object in the foreground;
selecting the target object for tracking without user intervention if the target object matches a user profile; and
tracking the target object.

68. The method of claim 67, wherein receiving the image further comprises receiving a GPS location with the image.

69. The method of claim 67, comprising receiving the image while the movable object is in one of translational flight or hovering flight.

70. The method of claim 69, comprising calculating at least one of a relative speed or direction of the movable object while the moveable object is in translational flight.

71. The method of claim 67, wherein the selecting is based on at least one of facial recognition, the user profile, motion detection, or a user selection.

72. The method of claim 67, wherein the extracting comprises detecting an attribute of the image.

73. The method of claim 72, wherein detecting an attribute of the image comprises detecting a movement in the image.

74. The method of claim 67, wherein the identifying comprises processing the foreground of the image through a neural network to identify the target object.

75. The method of claim 74, wherein the neural network is a deep learning neural network.

76. The method of claim 74, wherein the processing further comprises determining a set of control signals corresponding to a detected attribute of the image.

77. The method of claim 67, comprising detecting a feature of the target object as a trigger for initializing the tracking of the target object.

78. The method of claim 67, further comprises scanning a surrounding of the movable object and sensing for the target object by one or more sensors in real time.

79. The method of claim 78, wherein the one or more sensors comprise at least one of a vision, ultrasonic, or sonar sensor.

80. The method of claim 78, wherein the sensing is accomplished in combination with a global positioning system (GPS) location.

81. The method of claim 78, wherein the GPS location is a location of a wearable device.

82. The method of claim 77, wherein the detecting comprises detecting a kinematic feature related to the target object.

83. The method of claim 82, wherein the kinematic feature is a gesture.

84. The method of claim 82, wherein the kinematic feature is received from a wearable device.

85. The method of claim 77, wherein the detecting comprises determining if the target object is a known user based on recognizing a facial feature.

86. The method of claim 77, further comprising confirming the trigger by a visual notification.

87. An unmanned aerial vehicle (UAV), comprising:
a memory storing instructions for execution by a processor;
one or more propulsion devices; and
a flight controller in communication with the one or more propulsion devices and configured to control the UAV to track a target object, the flight controller having a processor configured to execute the stored instructions to:
receive an image;
extract a foreground of the image;
identify the target object in the foreground;
select the target object for tracking without user intervention if the target object matches a user profile; and
track the target object.

88. A non-transitory computer-readable medium storing instructions that, when executed by at least one processor, cause the at least one processor to perform a method of controlling a movable object, the method comprising:
receiving an image;
extracting a foreground of the image;
identifying a target object in the foreground;
selecting the target object for tracking without user intervention if the target object matches a user profile; and
tracking the target object.
